(19) United States
(12) Patent Application Publication
(10) Pub. No.: US 2022/0206505 A1
(43) Pub. Date: Jun. 30, 2022

(54) GEOMETRIC FOLDING FULL COVERAGE PATH FOR ROBOT AND METHOD FOR GENERATING SAME

(71) Applicant: SOUTHEAST UNIVERSITY, Nanjing (CN)

(72) Inventors: Lifeng ZHU, Nanjing (CN); Shuai YAO, Nanjing (CN); Aiguo SONG, Nanjing (CN)

(73) Assignee: SOUTHEAST UNIVERSITY, Nanjing (CN)

(21) Appl. No.: 17/535,671

(22) Filed: Nov. 25, 2021

Related U.S. Application Data
(63) Continuation of application No. PCT/CN2021/074630, filed on Feb. 1, 2021.

(30) Foreign Application Priority Data
Dec. 30, 2020 (CN) 202011617560.3

(51) Int. Cl. G05D 1/02

(52) U.S. Cl. CPC G05D 1/0217; G05D 1/0221

(57) ABSTRACT

A method for generating a geometric folding full coverage path for a robot is provided. A conventional full coverage path planning algorithm is based on a zigzag pattern, a spiral pattern or a combination thereof. A traversal order is restricted by a linear traversal manner or a traversal manner from inside to outside and therefore lacks flexibility. In the method, a geometric folding operation is used to generate a full coverage path pattern for the robot, referred to as a geometric folding path pattern. The full coverage path has a flexible traversal order. A representation method for the geometric folding path pattern is modeled in the method, and subsequently the method for randomly generating the geometric folding full coverage path and a search method for a geometric folding path within a constraint of passing through specified points in a given order are provided.

### CROSS REFERENCE TO THE RELATED APPLICATIONS

This application is a continuation application of International Application No. PCT/CN2021/074630, filed on Feb. 1, 2021, which is based upon and claims priority to Chinese Patent Application No. 202011617560.3, filed on Dec. 30, 2020, the entire contents of which are incorporated herein by reference.

### TECHNICAL FIELD

The present invention belongs to the application of information technology in the field of path planning for robots, and in particular, to a geometric folding full coverage path for a robot and a method for generating same.

### BACKGROUND

Full coverage path generation is one of the important topics in path planning for robots. A full coverage path is generated for a given area for a robot to pass every location in the area without bias or repetition. Full coverage path generation is a key technique in tasks such as unmanned aerial vehicle inspection, agricultural robot farming, industrial robot painting, and robotic vacuum cleaner movement.

Conventional full coverage path patterns for a robot usually involve reciprocating linear motion or spiral motion. Such a path is not very flexible and cannot satisfy a specific path ordering constraint or other requirements. On the other end, general free-space coverage curves are difficult to design due to their exponential level of complexity.

### SUMMARY

To resolve the above existing problems, the present invention provides a method for generating a geometric folding full coverage path for a robot. In the method, a novel full coverage path pattern which generalizes a linear motion pattern, and a spiral motion pattern is provided for a robot, and is referred to as a geometric folding full coverage pattern. Such a pattern is more flexible than a linear motion pattern and a spiral motion pattern. The search space is significantly reduced compared with a free space coverage curve, and an effective search can be made with an appropriate amount of calculation.

The present invention provides a geometric folding full coverage path for a robot, where the geometric folding full coverage path for a robot is generated through modeling. The full coverage path is modeled as a geometric form of a folded stamp sequence seen from a side view after a sequence of stamps are folded along the seams. When the stamps are folded in many different orders, different geometric forms are generated, and full coverage path patterns in such types of geometric forms are referred to as geometric folding full coverage paths;

the geometric folding full coverage path mainly runs in one direction, turns when running to either of two ends of the direction, and makes no turn during running in the direction; and

because each geometric folding full coverage path corresponds to one stamp folding sequence, it is defined that a storage pattern of the geometric folding full coverage path is a permutation a={a₁, a₂, . . . , aₙ}, where aᵢ is a sequence number of a layer in which an i^{th} stamp before folding is located after folding. Because a case of stamp sequence self-intersection may occur in stamp folding corresponding to any permutation, although each geometric folding full coverage path corresponds to one permutation, not every permutation corresponds to one geometric folding full coverage path. A geometric folding full coverage path for a robot is represented as a permutation without stamp folding self-intersection, and an algorithm for randomly generating a geometric folding full coverage path and an algorithm for generating a geometric folding full coverage path within an order constraint are further proposed, to generate a permutation in which no self-intersection is generated, to further obtain a geometric folding full coverage path.

The present invention provides a method for generating a geometric folding full coverage path for a robot, where the geometric folding full coverage path for a robot is generated by using an algorithm for generating a geometric folding full coverage path within an order constraint, and steps of the algorithm for generating a geometric folding full coverage path within an order constraint are as follows:

(1) sequentially specifying, by a user, grid points that need to be passed in an m×n grid, where it is assumed that a quantity of lines that need to be sequentially passed by a full coverage path is L={l₁, l₂, . . . , lₖ};

(2) enumerating all possibilities of selecting k elements from a sequence with a length of m, and for each choice, sequentially filling the elements l₁, l₂, . . . , lₖ, and filling 0 for the remaining elements, to obtain a set of arrays, where it is assumed that a set formed by all generated arrays is A, and A is an initial set of geometric folding full coverage paths;

(3) randomly selecting an element l from a complement L′={1, 2, . . . , m}−L of L in {1, 2, . . . , m}, randomly selecting an array a from A, and randomly selecting a position filled with 0 in a to replace the 0 with l′, to obtain a new array a′;

(4) examining whether a path corresponding to the array a′ has self-intersection, where two adjacent numbers in a′ form a crease {jl, jr}; if two number pairs {jl, jr} and {kl, kr} satisfy jr<kl or kr<jl, creases {jl, jr} and {kl, kr} do not intersect; if the two number pairs {jl, jr} and {kl, kr} satisfy kl 11<jr<kr, the crease {jl, jr} is nested in the crease {kl, kr}, and the two creases do not intersect; if the two number pairs {jl, jr} and {kl, kr} satisfy jl<kl<kr<jr, the crease {kl, kr} is nested in the crease {jl, jr}, and the two creases do not intersect; and in other cases, the crease {kl, kr} and the crease {jl, jr} intersect, all such number pairs in a′ are traversed, and in a case that two number pairs intersect corresponding to a crease, it is detected that self-intersection exists, and the array a′ is infeasible;

(5) if self-intersection exists, rejecting step (3), and performing the random selection operations in (3) again; if self-intersection does not exist, removing the element l′ from L′, continuing to randomly select an element in L′ and randomly inserting the element in a′, until all the elements in L′ have been inserted in a′; and if a feasible array fails to be found in a particular quantity of random insertion operations, continuing to return to a state before a previous insertion operation; and

(6) after a feasible permutation a is obtained, continuing to calculate a geometric path obtained by embedding a geometric form corresponding to stamp folding in the m×n grid, where it is only necessary to calculate a position {xᵢ, yᵢ} of a turning point for each line that a full coverage path runs here; first, aᵢ in the permutation a={a₁, a₂, . . . , aₘ} denotes a sequence number of a layer in which the path is located, and therefore yᵢ=aᵢ; a depth of the outermost crease of nesting is deemed as 0 according to a nesting relationship between the crease j and the crease k obtained in step (4), a depth dᵢ of a crease i may be established, it is finally set that a turning position at the crease i on the left side is xᵢ=dᵢ, and a turning position at the crease i on the right side is xᵢ=xₘₐₓ−dᵢ, to complete embedding of the geometric folding path in the grid, where xₘₐₓ is a maximum value of an x coordinate of a grid point; and if dᵢ>xₘₐₓ, it is determined that embedding of the permutation a in the grid is infeasible.

As a further improvement of the generation method of the present invention, the proposed order constraint for a geometric folding full coverage path is further set as a specified start point constraint and a specified end point constraint, lines in which a start point and an end point are located are specified as two order constraints that require to be satisfied, all feasible paths are enumerated, and a path having a start point and an end point that are respectively consistent with the given start point and end point is selected, to obtain a geometric folding full coverage path with a start point and an end point constrained.

As a further improvement of the generation method of the present invention, corresponding geometric folding full coverage paths with the given start point and end point are spliced, to obtain a full coverage path for a robot in a more complex area, to enable the robot to pass through every location in the area according to a given order preference, thereby generating a full coverage path of a corresponding task.

As a further improvement of the generation method of the present invention, the method for generating a geometric folding full coverage path for a robot is a method for randomly generating a geometric folding full coverage path within an order constraint, the random selection in step (3) is changed to full traversal, and all geometric folding full coverage paths that satisfy the order constraint may be enumerated.

As a further improvement of the generation method of the present invention, if an order constraint set L is set to an empty set, the foregoing method becomes a method for randomly generating a geometric folding full coverage path.

As a further improvement of the generation method of the present invention, if an initial array {l₁, l₂, . . . , lₖ, 0, 0, . . . , 0} is directly generated instead of generating the set A of all paths that satisfy an order requirement in step (2), a full coverage path obtained after subsequent operations on this basis is a path that preferentially pass through {l₁, l₂, . . . , lₖ} as much as possible.

As a further improvement of the generation method of the present invention, a stamp folding manner in the geometric form of the folded stamp sequence seen from the side after the sequence of stamps are folded along the seam is folding in a vertical direction, so that a corresponding full coverage path mainly runs in an x direction, or stamp folding in a transverse direction, so that a corresponding full coverage path mainly runs in a y direction.

As a further improvement of the generation method of the present invention, the geometric folding full coverage path is first deployed in a square grid area, and subsequently a spatial geometric deformation operation is performed according to a geometric boundary of a traversed area, to generate a full coverage path that covers a region with a free boundary.

As a further improvement of the generation method of the present invention, the full coverage path of the corresponding task in step 4 includes a full coverage path of a corresponding task such as unmanned aerial vehicle inspection, agricultural robot farming, industrial robot painting or robotic vacuum cleaner movement.

### Beneficial Effects

The geometric folding full coverage path for a robot and its generation method provided in the embodiments of the present invention have an advantage of better flexibility as compared with a linear motion pattern and a spiral motion pattern, a search space is significantly reduced compared with a free space coverage curve, and an effective search can be made with an appropriate amount of calculation. The present invention supports order control for a full coverage path for a robot, so that the full coverage path may pass through given control points according to an order, so that more control can be provided for full coverage path planning.

### BRIEF DESCRIPTION OF THE DRAWINGS

FIG. 1 is a flowchart of a method for randomly generating a geometric folding full coverage path;

FIG. 2 is a storage representation method of a geometric folding full coverage path;

FIG. 3 shows three cases of infeasible geometric folding;

FIG. 4 is a flowchart of a method for randomly generating a geometric folding full coverage path with a controllable order; and

FIG. 5 is a relationship diagram of a folding position of a geometric folding full coverage path.

### DETAILED DESCRIPTION OF THE EMBODIMENTS

The following further describes the present invention in detail with reference to the accompanying drawings and implementations.

Embodiments of the present invention provide a geometric folding full coverage path for a robot and a method for generating same. In the method, a novel full coverage path pattern between a linear motion pattern and a spiral motion pattern is provided for a robot, and is referred to as a geometric folding full coverage pattern. Such a pattern is more flexible than a linear motion pattern and a spiral motion pattern, a search space is significantly reduced compared with a free space coverage curve, and an effective search can be made with an appropriate amount of calculation.

As a specific embodiment of the present invention, this application provides the following technical solutions: A method for generating a geometric folding full coverage path for a robot includes the following content:

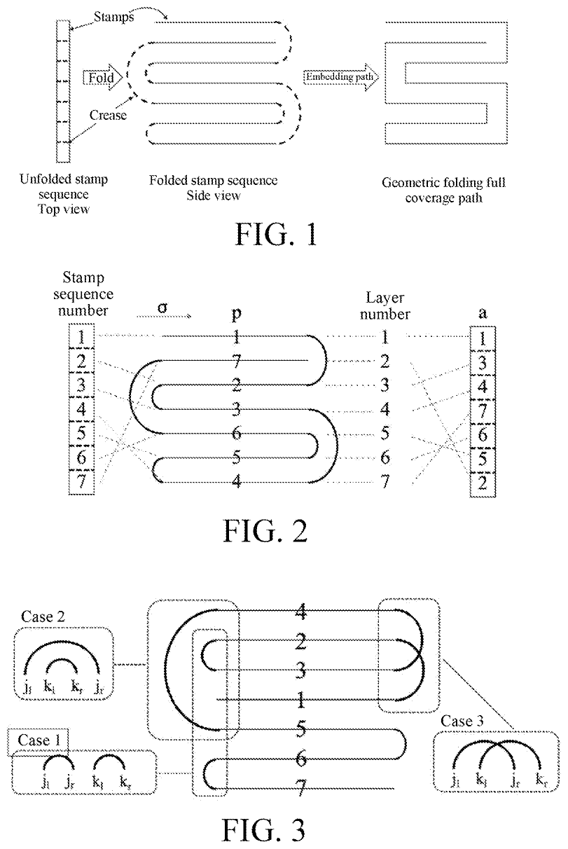

The full coverage path is modeled as a geometric form of a folded stamp sequence seen from a side after a sequence of stamps are folded along a seam (as shown in FIG. 1). When the stamps are folded in many different orders, different geometric forms are generated. In the present invention, full coverage path patterns in such types of geometric forms are referred to as geometric folding full coverage paths.

Because each geometric folding full coverage path corresponds to one stamp folding sequence, it is defined in the present invention that a storage pattern of the geometric folding full coverage path is a permutation a={a₁, a₂, . . . , aₙ}, where this a sequence number of a layer in which an i^{th} stamp before folding is located after folding (as shown in FIG. 2). Because a case of stamp sequence self-intersection may occur in stamp folding corresponding to any permutation (as shown in FIG. 3), although each geometric folding full coverage path corresponds to one permutation, not every permutation a corresponds to one geometric folding full coverage path. The present invention further proposes an algorithm for randomly generating a geometric folding full coverage path and an algorithm for generating a geometric folding full coverage path within an order constraint, to generate a permutation in which no self-intersection is generated, to further obtain a geometric folding full coverage path. Because the algorithm for randomly generating a geometric folding full coverage path is a specific example of the algorithm for generating a geometric folding full coverage path within an order constraint when an order constraint set is an empty set, the algorithm for generating a geometric folding full coverage path within an order constraint is first described in the present invention.

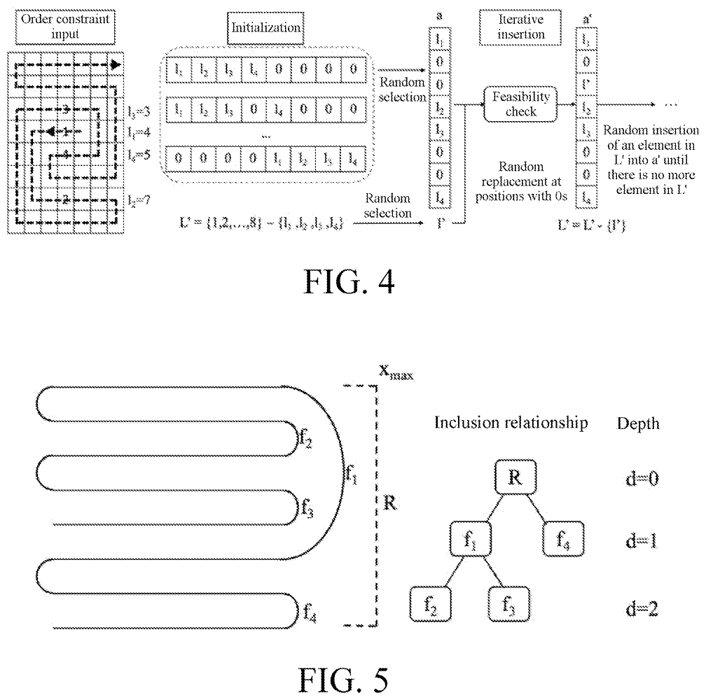

Steps of the method for generating a geometric folding full coverage path within an order constraint (as shown in FIG. 4) are as follows:

(1) sequentially specifying, by a user, grid points that need to be passed in an m×n grid, where it is assumed that a quantity of lines that need to be sequentially passed by a full coverage path is L={l₁, l₂, . . . , lₖ};

(2) enumerating all possibilities of selecting k elements from a sequence with a length of m, and for each choice, sequentially filling the elements l₁, l₂, . . . , lₖ, and filling 0 for the remaining elements, to obtain a set of arrays, where it is assumed that a set formed by all generated arrays is A, and A is an initial set of geometric folding full coverage paths;

(3) randomly selecting an element l′ from a complement L′={1, 2, . . . , m}−L of L in {1, 2, . . . , m}, randomly selecting an array a from A, and randomly selecting a position filled with 0 in a to replace the 0 with l′, to obtain a new array a′;

(4) examining whether a path corresponding to the array a′ has self-intersection, where two adjacent numbers in a′ form a crease {jl, jr}; if two number pairs {jl, jr} and {kl, kr} satisfy jr<kl or kr<jl, creases {jl, jr} and {kl, kr} do not intersect; if the two number pairs {jl, jr} and {kl, kr} satisfy kl<jl<jr<kr, the crease {jl, jr} is nested in the crease {kl, kr}, and the two creases do not intersect; if the two number pairs {jl, jr} and {kl, kr} satisfy jl<kl<kr<jr, the crease {kl, kr} is nested in the crease {jl, jr}, and the two creases do not intersect; and in other cases, the crease {kl, kr} and the crease {jl, jr} intersect, all such number pairs in a′ are traversed, and in a case that two number pairs intersect corresponding to a crease, it is detected that self-intersection exists, and the array a′ is infeasible (as shown in FIG. 3);

(5) if self-intersection exists, rejecting step (3), and performing the random selection operations in (3) again; if self-intersection does not exist, removing the element l′ from L′, continuing to randomly select an element in L′ and randomly inserting the element in a′, until all the elements in L′ have been inserted in a′; and if a feasible array fails to be found in a particular quantity of random insertion operations, continuing to return to a state before a previous insertion operation; and

(6) after a feasible permutation a is obtained, continuing to calculate a geometric path obtained by embedding a geometric form corresponding to stamp folding in the m×n grid, where it is only necessary to calculate a position {xᵢ, yᵢ} of a turning point for each line that a full coverage path runs here; first, aᵢ in the permutation a={a₁, a₂, . . . , aₘ} denotes a sequence number of a layer in which the path is located, and therefore yᵢ=aᵢ; a depth of the outermost crease of nesting is deemed as 0 according to a nesting relationship between the crease j and the crease k obtained in step (4), a depth dᵢ of a crease i may be established (as shown in FIG. 5), it is finally set that a turning position at the crease i on a left side is xᵢ=dᵢ, and a turning position at the crease i on a right side is xᵢ=xₘₐₓ−dᵢ, to complete embedding of the geometric folding path in the grid, where xₘₐₓ is a maximum value of an x coordinate of a grid point; and if dᵢ>xₘₐₓ, it is determined that embedding of the permutation a in the grid is infeasible.

The foregoing method is a method for randomly generating a geometric folding full coverage path within an order constraint, if the random selection in step (3) is changed to full traversal, and all geometric folding full coverage paths that satisfy the order constraint may be enumerated.

The foregoing method is a method for generating a geometric folding full coverage path within an order constraint, and if an order constraint set L is set to an empty set, the foregoing method becomes a method for randomly generating a geometric folding full coverage path.

In the foregoing method, if an initial array {l₁, l₂, . . . , lₖ, 0, 0, . . . , 0} is directly generated instead of generating the set A of all paths that satisfy an order requirement in step (2), a full coverage path obtained after subsequent operations on this basis is a path that preferentially pass through {l₁, l₂, . . . , lₖ} as much as possible.

In the foregoing description, assuming that a stamp folding manner is folding in a vertical direction, a corresponding full coverage path mainly runs in an x direction. The geometric folding full coverage path proposed in the present invention also corresponds to stamp folding in a transverse direction, so that a corresponding full coverage path may mainly runs in a y direction.

The proposed order constraint for a geometric folding full coverage path is further set as a specified start point constraint and a specified end point constraint, lines in which a start point and an end point are located are specified as two order constraints that require to be satisfied, all feasible paths are enumerated, and a path having a start point and an end point that are respectively consistent with the given start point and end point is selected, so that a geometric folding full coverage path with a start point and an end point constrained may be obtained.

A plurality of geometric folding full coverage paths with the given start point and end point are spliced, so that a full coverage path for a robot in a more complex area may be obtained, to enable the robot to pass every location in the area without bias or repetition according to a given order preference, to generate full coverage paths for tasks such as unmanned aerial vehicle inspection, agricultural robot farming, industrial robot painting, and robotic vacuum cleaner movement.

The geometric folding full coverage path proposed in the present invention may be first deployed in a square grid area, and subsequently a spatial geometric deformation operation may be performed according to a geometric boundary of a traversed area, to generate a full coverage path that covers a region with a free boundary.

The foregoing embodiments are only preferred embodiments of the present invention and are not to limit the present invention in any other forms. Any modification or equivalent change according to the technical essence of the present invention still fall within the scope of the present invention.

What is claimed is:

1. A geometric folding full coverage path for a robot, wherein the geometric folding full coverage path for the robot is generated through a modeling, the geometric folding full coverage path is modeled as a geometric form of a folded stamp sequence seen from a side after a sequence of stamps are folded along a seam, when the stamps are folded in different orders, different geometric forms are generated, and full coverage path patterns in such types of the different geometric forms are referred to as geometric folding full coverage paths;
the geometric folding full coverage path mainly runs in a direction, turns when running to either of two ends of the direction, and makes no turn during running in the direction; and
because each geometric folding full coverage path corresponds to one stamp folding sequence, a storage pattern of the geometric folding full coverage path is defined as a permutation a={a₁, a₂, . . . , aₙ}, wherein aᵢ is a sequence number of a layer, wherein an i^{th} stamp before folding is located in the layer after folding, because a case of a stamp sequence self-intersection occurs in a stamp folding corresponding to any permutation, although the each geometric folding full coverage path corresponds to one permutation, not every permutation a corresponds to one geometric folding full coverage path, the geometric folding full coverage path for the robot is represented as the permutation without a stamp folding self-intersection, and a first algorithm for randomly generating the geometric folding full coverage path and a second algorithm for generating the geometric folding full coverage path within an order constraint are further proposed, to generate the permutation, wherein no self-intersection is generated in the permutation, to further obtain the geometric folding full coverage path.

2. A method for generating a geometric folding full coverage path for a robot, wherein the geometric folding full coverage path for the robot is generated by using an algorithm for generating the geometric folding full coverage path within an order constraint, and steps of the algorithm for generating the geometric folding full coverage path within the order constraint are as follows:
(1) sequentially specifying, by a user, grid points to be passed in an m×n grid, assuming a quantity of lines to be sequentially passed by a full coverage path is L={l₁, l₂, . . . , lₖ};
(2) enumerating possibilities of selecting k elements from a sequence with a length of m, and for each choice, sequentially filling elements l₁, l₂, . . . , lₖ, and filling 0 for remaining elements, to obtain a set of arrays, assuming a set formed by generated arrays is A, and A is an initial set of geometric folding full coverage paths;
(3) randomly selecting an element l′ from a complement L′={1, 2, . . . , m}−L of L in {1, 2, . . . , m}, randomly selecting an array a from the initial set A, and randomly selecting a position filled with 0 in the array a to replace the 0 with the element l′, to obtain a new array a′;
(4) examining whether a path corresponding to the new array a′ has a self-intersection, wherein two adjacent numbers in the new array a′ form a crease {jl, jr}; when two number pairs {jl, jr} and {kl, kr} satisfy jr<kl or kr<jl, the crease {jl, jr} and a crease {kl, kr} do not intersect; when the two number pairs {jl, jr} and {kl, kr} satisfy kl<jl<jr<kr, the crease {jl, jr} is nested in the crease {kl, kr}, and the crease {jl, jr} and a crease {kl, kr} do not intersect; when the two number pairs {jl, jr} and {kl, kr} satisfy jl<kl<kr<jr, the crease {kl, kr} is nested in the crease {jl, jr}, and the crease {jl, jr} and a crease {kl, kr} do not intersect; and in other cases, the crease {kl, kr} and the crease {jl, jr} intersect, all such number pairs in the new array a′ are traversed, and when two number pairs intersect corresponding to a crease, detecting that self-intersection exists, and the new array a′ is infeasible;
(5) when the self-intersection exists, rejecting step (3), and performing random selection operations in step (3) again; when the self-intersection does not exist, removing the element l′ from the complement L′, continuing to randomly select an element in the complement L′ and randomly inserting the element in the new array a′, until all the elements in the complement L′ have been inserted in the new array a; and when a feasible array fails to be found in a particular quantity of random insertion operations, continuing to return to a state before a previous insertion operation; and
(6) after a feasible permutation a is obtained, continuing to calculate the geometric folding full coverage path obtained by embedding a geometric form corresponding to a stamp folding in the m×n grid, wherein a position {xᵢ, yᵢ} of a turning point for each line that the geometric folding full coverage path runs is calculated; first, aᵢ in the feasible permutation a={a₁, a₂, . . . , aₘ} denotes a sequence number of a layer, wherein in the layer the geometric folding full coverage path is located, and therefore yᵢ=aᵢ; a depth of an outermost crease of nesting is deemed as 0 according to a nesting relationship between the crease j and the crease k obtained in step (4), a depth di of a crease i may be established, setting a turning position at the crease i on a left side is xᵢ=dᵢ, and a turning position at the crease i on a right side is xᵢ=xₘₐₓ−dᵢ, to complete embedding of the geometric folding full coverage path in the m×n grid, wherein xₘₐₓ is a maximum value of an x coordinate of a grid point; and when dᵢ>xₘₐₓ, determining that embedding of the feasible permutation a in the m×n grid is infeasible.

3. The method according to claim 2, wherein the order constraint for the geometric folding full coverage path is further set as a specified start point constraint and a specified end point constraint, a start point and an end point are located in lines, and the lines are specified as two order constraints requiring to be satisfied, feasible paths are enumerated, and a path having the start point and the end point respectively consistent with a given start point and a given end point is selected, to obtain the geometric folding full coverage path with the start point and the end point constrained.

4. The method according to claim 2, wherein the geometric folding full coverage paths with a given start point and a given end point are spliced, to obtain the geometric folding full coverage path for the robot in a complex area, to enable the robot to pass through every location in the complex area according to a given order preference to generate the geometric folding full coverage path of a corresponding task.

5. The method according to claim 2, comprising randomly generating the geometric folding full coverage path within the order constraint, a random selection in step (3) is changed to a full traversal, and the geometric folding full coverage paths satisfying the order constraint are enumerated.

6. The method according to claim 2, wherein when an order constraint set L is set to an empty set, the method randomly generates the geometric folding full coverage path.

7. The method according to claim 2, wherein when an initial array {l₁, l₂, . . . , lₖ, 0, 0, . . . , 0} is directly generated instead of generating the initial set A of paths satisfying an order requirement in step (2), the geometric folding full coverage path obtained after subsequent operations on a basis is a path preferentially passing through {l₁, l₂, . . . , lₖ}.

8. The method according to claim 2, wherein a stamp folding manner in the geometric form of a folded stamp sequence seen from a side after a sequence of stamps are folded along a seam is folding in a vertical direction, wherein a corresponding full coverage path mainly runs in an x direction, or the stamp folding in a transverse direction, wherein the corresponding full coverage path mainly runs in a y direction.

9. The method according to claim 2, wherein the geometric folding full coverage path is first deployed in a square grid area, and subsequently a spatial geometric deformation operation is performed according to a geometric boundary of a traversed area, to generate the geometric folding full coverage path satisfying a free boundary.

10. The method according to claim 2, wherein the geometric folding full coverage path of a corresponding task in step (4) comprises an unmanned aerial vehicle inspection, an agricultural robot farming, an industrial robot painting or a robotic vacuum cleaner movement.
